(19) United States
(12) Patent Application Publication
(10) Pub. No.: US 2023/0075219 A1
(43) Pub. Date: Mar. 9, 2023

(54) CARD TRANSACTION APPROVAL USING PREDICTIVE ANALYTICS MACHINE LEARNING

(71) Applicant: INTERNATIONAL BUSINESS MACHINES CORPORATION, Armonk, NY (US)

(72) Inventors: Joshi Mathew Chirayil, PHOENIX, AZ (US); Deepak Gupta, Indirapuram (IN); Vivek Kumar, Phoenix, AZ (US); Siddharth K. Saraya, Raniganj (IN)

(21) Appl. No.: 17/470,021

(22) Filed: Sep. 9, 2021

(51) Int. Cl. G06Q 20/40; G06Q 20/34

(52) U.S. Cl. CPC G06Q 20/4014; G06Q 20/34

(57) ABSTRACT

An approach is provided for authorizing a card transaction. Data about spending by a user is received by a computer system, which is a server computer of a trade organization established by a card provider organization to include multiple merchants. The computer system is configured to authorize or decline card transactions. A predictive pattern of spending by the user is determined. A card transaction is detected. The card transaction is initiated by the user using a card to make a purchase from a merchant included in the trade organization. Card transaction information about the card transaction is obtained via an intranet. It is determined that the card transaction information matches the predictive pattern of spending. The card transaction is authorized without sending the card transaction information via the internet, or to a server or computer network of the card provider organization.

### BACKGROUND

The present invention relates to card transaction authorization, and more particularly to validating card transactions at a trade organization level.

A card transaction involves an authorization followed by a settlement. The authorization portion of the card transaction includes a flow of steps that involve the cardholder, merchant, acquiring bank (i.e., the merchant's bank) (or the acquiring bank's processor), card association's network, and issuing bank (i.e., issuer of the card used to initiate the card transaction). The cardholder begins a card transaction by presenting a card at the merchant's terminal as a payment for goods or services. The merchant's terminal passes cardholder information and transaction information to the acquiring bank or its processor. The acquiring bank (or its processor) routes the transaction information through the card association's network to the issuing bank for approval. The issuing bank validates the transaction information and ensures that the cardholder has sufficient balance to make the purchase and that the cardholder's account is in good standing. The issuing bank sends the authorization for the transaction via the card association's network to the acquiring bank (or its processor), which then transmits the authorization to the merchant's terminal, software, or gateway, where the authorization is stored in a batch file awaiting settlement.

Card transactions and virtual money transactions are replacing cash transactions at a very fast pace for reasons that include the buyer not having cash and the seller not having enough change to tender. Because the number of transactions is increasing rapidly and continuously, there are attempts to attain faster internet processing and faster computing speeds to resolve the transactions and to increase the amount of storage space for all the transactions.

### SUMMARY

In one embodiment, the present invention provides a computer system that includes a central processing unit (CPU), a memory coupled to the CPU, and one or more computer readable storage media coupled to the CPU. The one or more computer readable storage media collectively contain instructions that are executed by the CPU via the memory to implement a method of authorizing a card transaction. The method includes the computer system receiving data about spending by a user. The computer system is a server computer of a trade organization. The trade organization is established by a card provider organization to include multiple merchants. The server computer of the trade organization is configured to authorize or decline card transactions. The method further includes based on the received data about spending by the user and using a machine learning system, the computer system determining a predictive pattern of spending by the user. The method further includes the computer system detecting a card transaction initiated by the user using a card to make a purchase from a merchant included in the trade organization and obtaining card transaction information about the card transaction via an intranet. The method further includes the computer system determining that the card transaction information matches the predictive pattern of spending. The method further includes in response to the determining that the card transaction information matches the predictive pattern of spending, the computer system authorizing the card transaction without sending the card transaction information via the internet and without sending the card transaction information to a server of the card provider organization or a computer network of the card provider organization.

A computer program product and a method corresponding to the above-summarized computer system are also described and claimed herein.

### BRIEF DESCRIPTION OF THE DRAWINGS

FIG. 1 is a block diagram of a system for authorizing a card transaction at a trade organization level, in accordance with embodiments of the present invention.

FIGS. 2A-2B depict a flowchart of a process of authorizing a card transaction at a trade organization level, in accordance with embodiments of the present invention.

FIG. 3 is a block diagram of a computer that is included in the system of FIG. 1 and that implements the process of FIGS. 2A-2B, in accordance with embodiments of the present invention.

### DETAILED DESCRIPTION

### Overview

As the number of card transactions continuously increases, unauthorized interruptions in known card transaction system increases, which result in increased costs and card sales not being deposited in a timely manner. With known card transaction systems, it is costly and difficult to acquire the fast internet and computing speeds needed to resolve the increased number of card transactions. Furthermore, it is costly for the entities involved in authentication provided by known card transaction systems to obtain greater amounts of storage space required by the increased number of card transactions.

Embodiments of the present invention address the aforementioned unique challenges of managing card transactions by authorizing card transactions at a trade organization level, where a trade organization is a group of businesses provided as an entity in a card transaction authentication process, and where the trade organization authorizes card transactions in an independent mode via an intranet, without requiring a connection to the internet. By decreasing the usage of the internet, card transaction authorization technique described herein reduces the risk of unauthorized system interruptions, thereby avoiding the associated costs and loss or delay of sales deposits. Embodiments of the present invention provide local authorization of card transactions by a trade organization, where the authorization decision is based on predictive analytics (i.e., a predictive spend pattern within the trade organization). The spend pattern is based on learning done by a machine learning system using information about card transactions within a particular trade organization. The local authorization of card transactions based on the predictive spend pattern provides quicker authorizations of card transactions, without compromising on security of the card transaction information, and while avoiding delays that occur in conventional authorization approaches that transmit transaction information to a card association server for every transaction. Embodiments of the present invention provide a robust card transaction authentication system by distributing the authentication mechanism over various trade organization nodes, thereby avoiding the silo configuration of conventional card transaction authentication systems that require all card transaction approvals to be processed through card association networks.

In one embodiment, the authorization of card transactions at a trade organization level decreases the need of an internet connection with all merchants because data is passed within an intranet at the trade organization level. In one embodiment, the card transaction authorization approach described herein includes an intermediary card service by a trade organization, where the intermediary card service formulates a distributed processing system with controls, which decreases the count of transactions processed at a server of a card provider organization.

In one embodiment, the card transaction authorization technique that uses validation at the trade organization level identifies individual spending patterns and captures multiple parameters, which include the amounts spent on the card transactions, identifications of the vendors involved in the card transactions, and the times of the card transactions. The card transaction authentication technique described herein determines approved limits to variances from the spending patterns and over a collection of data points provided by card transactions, determines whether the approved limits to the variances need to be modified. In one embodiment, as a cardholder spends using the card in a card transaction, the spending is mapped to the spending pattern of the cardholder, and if the spending matches the spending pattern within the approved limit to the variance from the spending pattern, then the card transaction is authorized at a server of the trade organization without being sent to the server of the card association, or if the spending does not match the spending pattern, the card transaction is sent to the server of the card association for authorization and verification.

### System for Authorizing a Card Transaction at a Trade Organization Level

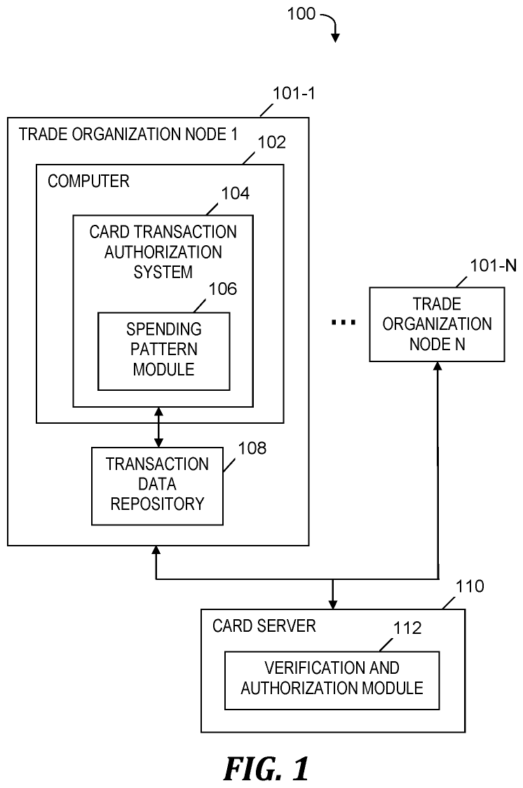

FIG. 1 is a block diagram of a system 100 for authorizing a card transaction at a trade organization level, in accordance with embodiments of the present invention. System 100 includes trade organization nodes 101-1, . . . , 101-N, which are associated with N merchants included in a trade organization established by a card provider organization, and where N is an integer greater than or equal to one. Trade organization node 101-1 includes a computer 102 that includes a software-based card transaction authorization system 104, which includes a spending pattern module 106. Card transaction authorization system 104 stores transaction data in a transaction data repository 108, which is operatively coupled to computer 102. Other trade organization nodes in system 100, such as trade organization node 101-N, include components (not shown) that match the components and match the functionality of the components shown in trade organization node 101-1.

Spending pattern module 106 includes a machine learning system (not shown) that identifies a spending pattern of a user by capturing multiple parameters within a single trade organization, including an amount spent by the user for purchases made by card transactions initiated by the user, merchants who sold goods and/or services purchased by the user, and timestamps (i.e., dates and times) of the card transactions initiated by the user. The spending pattern for the user within a single trade organization identifies a maximum spending amount, a maximum spending amount per merchant, the number of merchants from which goods and/or services were purchased, and the date and time of purchases.

Card transaction authorization system 104 receives or determines an approved limit of variance from the spending pattern. The aforementioned approved limit of variance is also referred to herein as an acceptable range of variation. Card transaction authorization system 104 may set or modify the approved limit of variance based on a collection of data points that include the aforementioned multiple parameters including the amounts spent, the merchants, and the timestamps of the card transactions.

In response to a user initiating a current card transaction to make a purchase, card transaction authorization system 104 maps the user's spending via the current card transaction to the spending pattern determined by spending pattern module 106. If card transaction authorization system 104 determines that the user's spending via the current card transaction matches the spending pattern, then card transaction authorization system 104 authorizes (i.e., approves) the current card transaction at the server of the trade organization (i.e., at computer 102), without a transmission of information about the current card transaction to a card server 110 (i.e., a server of a card association).

If card transaction authorization system 104 determines that the user's spending via the current card transaction does not match the spending pattern, then card transaction authorization system 104 does not approve the current card transaction and sends information about the current transaction to card server 110 for verification and authorization of the current card transaction by verification and authorization module 112.

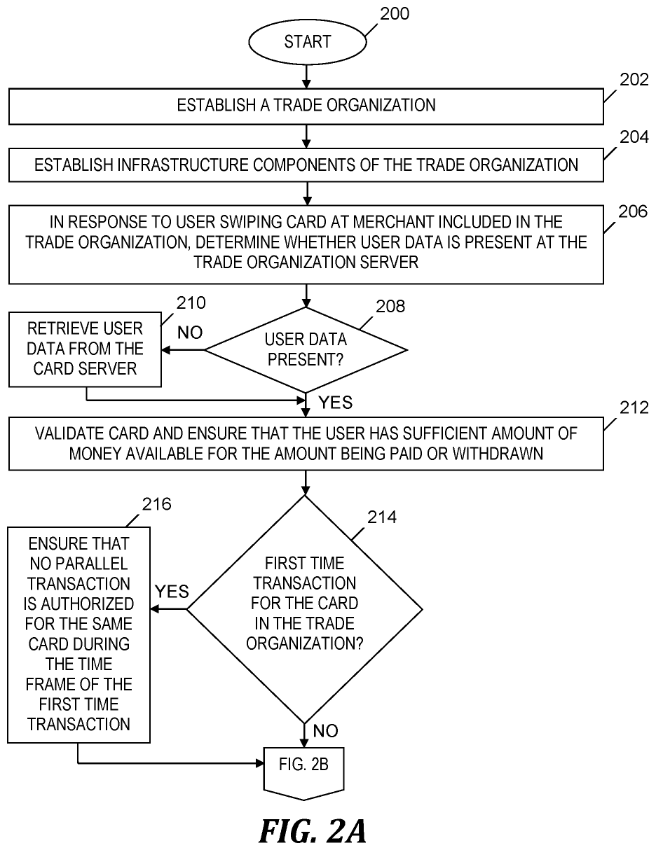

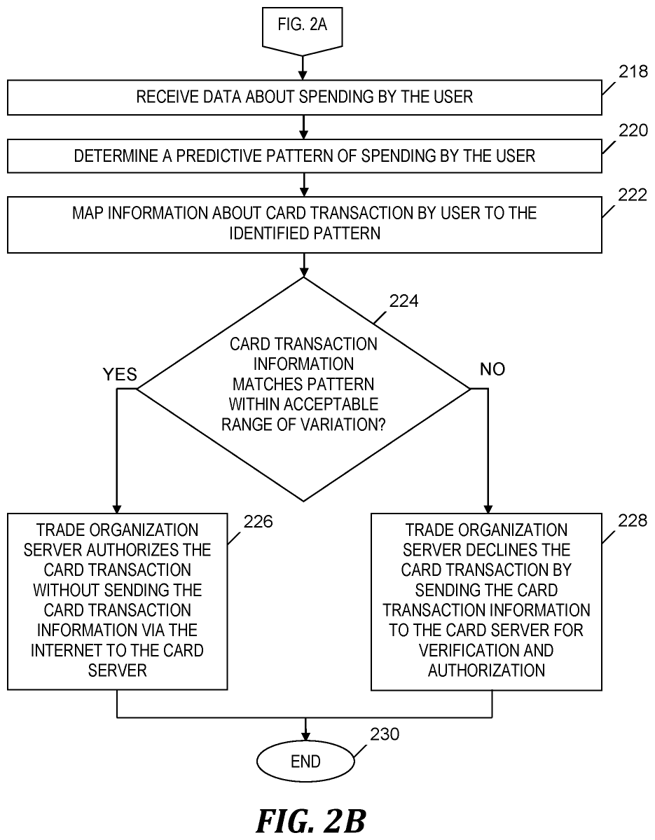

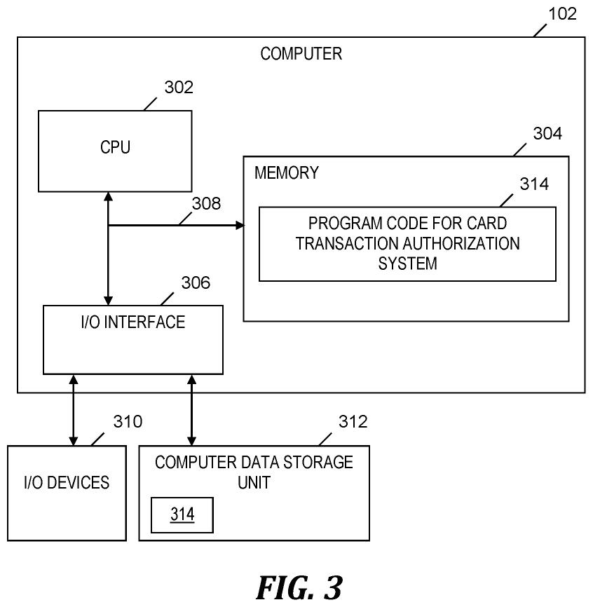

The functionality of the components shown in FIG. 1 is described in more detail in the discussion of FIGS. 2A-2B and FIG. 3 presented below.

### Process for Authorizing a Card Transaction at a Trade Organization Level

FIGS. 2A-2B depict a flowchart of a process of authorizing a card transaction at a trade organization level, in accordance with embodiments of the present invention. The process of FIGS. 2A-2B begins at a start node 200 in FIG. 2A. In step 202, a card provider organization establishes a trade organization comprising multiple merchants (i.e., a group of businesses) in a given area (e.g., a group of merchants that are physically co-located). In a case in which a commercial entity is not part of a trade organization, the commercial entity can be made a part of the trade organization. An e-business entity may set up a trade organization for its own use. The trade organization allows for user registration and an entry of the user's preferred payment options. Each card provider organization identifies trade organizations as entities. To establish a trade organization, each card provider organization shares its government registration certificates and list of associate members.

In step 204, the card provider organization establishes infrastructure on the premises of the trade organization established in step 202, where the infrastructure includes a server computer (e.g., computer 102 (see FIG. 1)) of the trade organization, a data repository (e.g., transaction data repository 108 (see FIG. 1)), and a software component that is executed in the server computer and that provides functionality to authorize or decline card transactions.

Subsequent to step 204 and prior to step 206, a user swipes a card (i.e., credit card or debit card) at a terminal of a merchant in the trade organization. In step 206, in response to the user swiping the card, card transaction authorization system 104 (see FIG. 1) determines whether user data (i.e., data about the user who swipes the card) is present at the trade organization server.

In step 208, if card transaction authorization system 104 (see FIG. 1) determines that user data is not present at the trade organization server, then the No branch of step 208 is followed and step 210 is performed. In step 210, card transaction authorization system 104 (see FIG. 1) retrieves the user data from card server 110 (see FIG. 1).

Returning to step 208, if card transaction authorization system 104 (see FIG. 1) determines that the user data is present at the trade organization server, then the Yes branch of step 208 is followed and step 212 is performed. Step 212 also follows step 210.

In step 212, card transaction authorization system 104 (see FIG. 1) validates the card for authentication and ensures that the user has a sufficient amount of money available to spend or dispense from an account associated with the card to provide the amount being paid or withdrawn via the card transaction.

In step 214, card transaction authorization system 104 (see FIG. 1) determines whether the card transaction is a first time transaction for the card being used for a purchase from a given merchant in the trade organization. If card transaction authorization system 104 (see FIG. 1) determines that the card transaction is a first time transaction, then the Yes branch of step 214 is followed and step 216 is performed.

In step 216, the card server 110 (see FIG. 1) prevents an authorization of any parallel card transaction associated with the trade organization for the same card during the time frame of the first time transaction, until a sync occurs between the trade organization server and the card server 110 (see FIG. 1). Card server 110 (see FIG. 1) employs verification and authorization module 112 (see FIG. 1) to authorize the first time transaction. After step 218, card transaction authorization system 104 (see FIG. 1) detects subsequent card transactions initiated by the user swiping the card at the same merchant or a different merchant in the same trade organization and the steps in FIG. 2B are performed for the subsequent card transactions.

Returning to step 214, if card transaction authorization system 104 (see FIG. 1) determines that the card transaction is not a first time transaction, then the No branch of step 214 is followed and the process of FIGS. 2A-2B continues with step 218 in FIG. 2B.

In step 218, card transaction authorization system 104 (see FIG. 1) receives data about spending by the user.

In step 220, based on the data about the spending by user received in step 218, card transaction authorization system 104 (see FIG. 1) using a machine learning system determines a predictive pattern of spending by the user.

In step 222, card transaction authorization system 104 (see FIG. 1) maps information about the card transaction initiated by the user to the pattern identified in step 220.

In step 224, based on the mapping in step 222, card transaction authorization system 104 (see FIG. 1) determines whether the information about the card transaction matches the pattern identified in step 220 within an acceptable range of variation. Prior to step 224, card transaction authorization system 104 (see FIG. 1) receives as input or determines the acceptable range of variation.

If card transaction authorization system 104 (see FIG. 1) determines in step 224 that the information about the card transaction matches the pattern identified in step 220, then the Yes branch of step 224 is followed and step 226 is performed.

In step 226, card transaction authorization system 104 (see FIG. 1) authorizes the card transaction without sending the information about the card transaction via the internet or to the card server 110 (see FIG. 1). In one embodiment, card transaction authorization system 104 (see FIG. 1) authorizes the card transaction in step 226 even though computer 102 is in a disconnected state from the internet.

Returning to step 224, if card transaction authorization system 104 (see FIG. 1) determines that the information about the card transaction does not match the pattern identified in step 220, then the No branch of step 224 is followed and step 228 is performed.

In step 228, card transaction authorization system 104 (see FIG. 1) declines the card transaction by sending the information about the card transaction to card server 110 (see FIG. 1) for verification and authorization by verification and authorization module 112 (see FIG. 1).

Following step 228 and following step 226, the process of FIGS. 2A-2B ends at an end node 230.

Although not shown in FIG. 2B, after step 226 or step 228, card transaction authorization system 104 (see FIG. 1) detects one or more subsequent card transactions initiated by the user swiping the card at the same merchant or a different merchant in the same trade organization and the steps in FIG. 2B are performed for the one or more subsequent card transactions. In one embodiment, card transaction authorization system 104 (see FIG. 1) detects fraud and/or performs re-authorization in a case of the user swiping the card in a terminal of a merchant that is not included in the trade organization.

In one embodiment, a settlement component (not shown in FIG. 1) of card server 110 (see FIG. 1) performs a cumulative settlement for all transactions belonging to a given trade organization, rather than to individual merchants. Card server 110 (see FIG. 1) can pull details of transactions from the merchant on an as needed basis.

In one embodiment, as the settlement component settles the card transactions after verification by the trade organization server, the card transactions are rolled up in parallel to card server 110 for authentication.

In one embodiment, card transaction authorization system 104 (see FIG. 1) receives an interval of time for synching card transactions and subsequently determines that the interval of time has elapsed. In response to determining that the interval of time has elapsed, card transaction authorization system 104 (see FIG. 1) collectively syncs multiple card transactions to card server 110 (see FIG. 1).

In one embodiment, card transaction authorization system 104 (see FIG. 1) receives a specified time frame for removing data about users and subsequently determines that for the specified time frame, a user has not initiated any card transactions for purchasing from any merchant included in the multiple merchants included in the trade organization. In response to determining that for the specified time frame, the user has not initiated any card transaction for purchasing from any merchant in the trade organization, card transaction authorization system 104 (see FIG. 1) removes data about the user from transaction data repository 108 (see FIG. 1).

### Computer System

FIG. 3 is a block diagram of a computer that is included in the system of FIG. 1 and that implements the process of FIGS. 2A-2B, in accordance with embodiments of the present invention. Computer 102 is a computer system that generally includes a central processing unit (CPU) 302, a memory 304, an input/output (I/O) interface 306, and a bus 308. Further, computer 102 is coupled to I/O devices 310 and a computer data storage unit 312. CPU 302 performs computation and control functions of computer 102, including executing instructions included in program code 314 for card transaction authorization system 104 (see FIG. 1) to perform a method of authorizing a card transaction at a trade organization level, where the instructions are executed by CPU 302 via memory 304. CPU 302 may include a single processing unit or processor or be distributed across one or more processing units or one or more processors in one or more locations (e.g., on a client and server).

Memory 304 includes a known computer readable storage medium, which is described below. In one embodiment, cache memory elements of memory 304 provide temporary storage of at least some program code (e.g., program code 314) in order to reduce the number of times code must be retrieved from bulk storage while instructions of the program code are executed. Moreover, similar to CPU 302, memory 304 may reside at a single physical location, including one or more types of data storage, or be distributed across a plurality of physical systems or a plurality of computer readable storage media in various forms. Further, memory 304 can include data distributed across, for example, a local area network (LAN) or a wide area network (WAN).

I/O interface 306 includes any system for exchanging information to or from an external source. I/O devices 310 include any known type of external device, including a display, keyboard, etc. Bus 308 provides a communication link between each of the components in computer 102, and may include any type of transmission link, including electrical, optical, wireless, etc.

I/O interface 306 also allows computer 102 to store information (e.g., data or program instructions such as program code 314) on and retrieve the information from computer data storage unit 312 or another computer data storage unit (not shown). Computer data storage unit 312 includes one or more known computer readable storage media, where a computer readable storage medium is described below. In one embodiment, computer data storage unit 312 is a non-volatile data storage device, such as, for example, a solid-state drive (SSD), a network-attached storage (NAS) array, a storage area network (SAN) array, a magnetic disk drive (i.e., hard disk drive), or an optical disc drive (e.g., a CD-ROM drive which receives a CD-ROM disk or a DVD drive which receives a DVD disc).

Memory 304 and/or storage unit 312 may store computer program code 314 that includes instructions that are executed by CPU 302 via memory 304 to authorize a card transaction at a trade organization level. Although FIG. 3 depicts memory 304 as including program code, the present invention contemplates embodiments in which memory 304 does not include all of code 314 simultaneously, but instead at one time includes only a portion of code 314.

Further, memory 304 may include an operating system (not shown) and may include other systems not shown in FIG. 3.

As will be appreciated by one skilled in the art, in a first embodiment, the present invention may be a method; in a second embodiment, the present invention may be a system; and in a third embodiment, the present invention may be a computer program product.

Any of the components of an embodiment of the present invention can be deployed, managed, serviced, etc. by a service provider that offers to deploy or integrate computing infrastructure with respect to authorizing a card transaction at a trade organization level. Thus, an embodiment of the present invention discloses a process for supporting computer infrastructure, where the process includes providing at least one support service for at least one of integrating, hosting, maintaining and deploying computer-readable code (e.g., program code 314) in a computer system (e.g., computer 102) including one or more processors (e.g., CPU 302), wherein the processor(s) carry out instructions contained in the code causing the computer system to authorize a card transaction at a trade organization level. Another embodiment discloses a process for supporting computer infrastructure, where the process includes integrating computer-readable program code into a computer system including a processor. The step of integrating includes storing the program code in a computer-readable storage device of the computer system through use of the processor. The program code, upon being executed by the processor, implements a method of authorizing a card transaction at a trade organization level.

While it is understood that program code 314 for authorizing a card transaction at a trade organization level may be deployed by manually loading directly in client, server and proxy computers (not shown) via loading a computer-readable storage medium (e.g., computer data storage unit 312), program code 314 may also be automatically or semi-automatically deployed into computer 102 by sending program code 314 to a central server or a group of central servers. Program code 314 is then downloaded into client computers (e.g., computer 102) that will execute program code 314. Alternatively, program code 314 is sent directly to the client computer via e-mail. Program code 314 is then either detached to a directory on the client computer or loaded into a directory on the client computer by a button on the e-mail that executes a program that detaches program code 314 into a directory. Another alternative is to send program code 314 directly to a directory on the client computer hard drive. In a case in which there are proxy servers, the process selects the proxy server code, determines on which computers to place the proxy servers' code, transmits the proxy server code, and then installs the proxy server code on the proxy computer. Program code 314 is transmitted to the proxy server and then it is stored on the proxy server.

Another embodiment of the invention provides a method that performs the process steps on a subscription, advertising and/or fee basis. That is, a service provider can offer to create, maintain, support, etc. a process of authorizing a card transaction at a trade organization level. In this case, the service provider can create, maintain, support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The present invention may be a system, a method, and/or a computer program product at any possible technical detail level of integration. The computer program product may include a computer readable storage medium (or media) (i.e., memory 304 and computer data storage unit 312) having computer readable program instructions 314 thereon for causing a processor (e.g., CPU 302) to carry out aspects of the present invention.

The computer readable storage medium can be a tangible device that can retain and store instructions (e.g., program code 314) for use by an instruction execution device (e.g., computer 102). The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions (e.g., program code 314) described herein can be downloaded to respective computing/processing devices (e.g., computer 102) from a computer readable storage medium or to an external computer or external storage device (e.g., computer data storage unit 312) via a network (not shown), for example, the Internet, a local area network, a wide area network and/or a wireless network. The network may comprise copper transmission cables, optical transmission fibers, wireless transmission, routers, firewalls, switches, gateway computers and/or edge servers. A network adapter card (not shown) or network interface (not shown) in each computing/processing device receives computer readable program instructions from the network and forwards the computer readable program instructions for storage in a computer readable storage medium within the respective computing/processing device.

Computer readable program instructions (e.g., program code 314) for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations (e.g., FIGS. 2A-2B) and/or block diagrams (e.g., FIG. 1 and FIG. 3) of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions (e.g., program code 314).

These computer readable program instructions may be provided to a processor (e.g., CPU 302) of a general purpose computer, special purpose computer, or other programmable data processing apparatus (e.g., computer 102) to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium (e.g., computer data storage unit 312) that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions (e.g., program code 314) may also be loaded onto a computer (e.g. computer 102), other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

The claims are as follows:

1. A computer system comprising:
a central processing unit (CPU);
a memory coupled to the CPU; and
one or more computer readable storage media coupled to the CPU, the one or more computer readable storage media collectively containing instructions that are executed by the CPU via the memory to implement a method of authorizing a card transaction, the method comprising:
the computer system receiving data about spending by a user, the computer system being a server computer of a trade organization, the trade organization being established by a card provider organization to include multiple merchants, and the server computer of the trade organization being configured to authorize or decline card transactions;
based on the received data about spending by the user and by using a machine learning system, the computer system determining a predictive pattern of spending by the user;
the computer system detecting a card transaction initiated by the user using a card to make a purchase from a merchant included in the trade organization and obtaining card transaction information about the card transaction via an intranet;
the computer system determining that the card transaction information matches the predictive pattern of spending; and
in response to the determining that the card transaction information matches the predictive pattern of spending, the computer system authorizing the card transaction without sending the card transaction information via the internet and without sending the card transaction information to a server of the card provider organization or a computer network of the card provider organization.

2. The computer system of claim 1, wherein the method further comprises:
the computer system detecting a second card transaction initiated by a usage of the card to make a second purchase and obtaining second card transaction information about the second card transaction via the intranet;
the computer system determining that the second card transaction information does not match the predictive pattern of spending; and
in response to the determining that the second card transaction information does not match the predictive pattern of spending, the computer system declining the second card transaction by sending the second card transaction information to the server of the card provider organization for a verification and an authorization of the second card transaction.

3. The computer system of claim 1, wherein the method further comprises:
the computer system receiving a range of variation from the predictive pattern of spending, wherein the determining that the card transaction information matches the predictive pattern of spending includes determining a variance that the card transaction information has from the predictive pattern of spending and determining that the variance is within the range of variation.

4. The computer system of claim 1, wherein the method further comprises:
the computer system detecting a first time card transaction initiated by the user using the card for purchasing from the merchant included in the trade organization, the first time card transaction being a first time the card is used for purchasing from any merchant included in the multiple merchants included in the trade organization; and
in response to the detecting the first time card transaction, the computer system preventing an authorization of a parallel card transaction associated with the trade organization during a time frame of the first time card transaction, until a sync occurs between the computer system and the server computer of the card provider organization.

5. The computer system of claim 1, wherein the method further comprises:
the computer system receiving an interval of time for syncing card transactions;
the computer system determining that the interval of time has elapsed; and
in response to the determining that the interval of time has elapsed, the computer system collectively syncing multiple card transactions to the server computer of the card provider organization.

6. The computer system of claim 1, wherein the method further comprises:
the computer system receiving a specified time frame for removing data about users;
the computer system determining that for the specified time frame, the user has not initiated any card transaction for purchasing from any merchant included in the multiple merchants included in the trade organization; and
in response to the determining that for the specified time frame, the user has not initiated any card transaction for purchasing from any merchant included in the multiple merchants, the computer system removing data about the user from the server computer of the trade organization.

7. The computer system of claim 1, wherein the method further comprises:
the computer system detecting the card being swiped in a merchant terminal by the user;
in response to the detecting the card being swiped, the computer system determining whether data about the user is present on the server computer of the trade organization; and
if the data about the user is not present on the server computer of the trade organization, the computer system receiving the data about the user from the server of the card provider organization, or if the data about the user is present on the server computer of the trade organization, the computer system validating the card for authentication and determining whether money available to the user for spending or dispensing is within a current limit associated with the card.

8. A computer program product for authorizing a card transaction, the computer program product comprising:
one or more computer readable storage media having computer readable program code collectively stored on the one or more computer readable storage media, the computer readable program code being executed by a central processing unit (CPU) of a computer system to cause the computer system to perform a method comprising:
the computer system receiving data about spending by a user, the computer system being a server computer of a trade organization, the trade organization being established by a card provider organization to include multiple merchants, and the server computer of the trade organization being configured to authorize or decline card transactions;
based on the received data about spending by the user and by using a machine learning system, the computer system determining a predictive pattern of spending by the user;
the computer system detecting a card transaction initiated by the user using a card to make a purchase from a merchant included in the trade organization and obtaining card transaction information about the card transaction via an intranet;
the computer system determining that the card transaction information matches the predictive pattern of spending; and
in response to the determining that the card transaction information matches the predictive pattern of spending, the computer system authorizing the card transaction without sending the card transaction information via the internet and without sending the card transaction information to a server of the card provider organization or a computer network of the card provider organization.

9. The computer program product of claim 8, wherein the method further comprises:
the computer system detecting a second card transaction initiated by a usage of the card to make a second purchase and obtaining second card transaction information about the second card transaction via the intranet;
the computer system determining that the second card transaction information does not match the predictive pattern of spending; and
in response to the determining that the second card transaction information does not match the predictive pattern of spending, the computer system declining the second card transaction by sending the second card transaction information to the server of the card provider organization for a verification and an authorization of the second card transaction.

10. The computer program product of claim 8, wherein the method further comprises:
the computer system receiving a range of variation from the predictive pattern of spending, wherein the determining that the card transaction information matches the predictive pattern of spending includes determining a variance that the card transaction information has from the predictive pattern of spending and determining that the variance is within the range of variation.

11. The computer program product of claim 8, wherein the method further comprises:
the computer system detecting a first time card transaction initiated by the user using the card for purchasing from the merchant included in the trade organization, the first time card transaction being a first time the card is used for purchasing from any merchant included in the multiple merchants included in the trade organization; and
in response to the detecting the first time card transaction, the computer system preventing an authorization of a parallel card transaction associated with the trade organization during a time frame of the first time card transaction, until a sync occurs between the computer system and the server computer of the card provider organization.

12. The computer program product of claim 8, wherein the method further comprises:
the computer system receiving an interval of time for syncing card transactions;
the computer system determining that the interval of time has elapsed; and
in response to the determining that the interval of time has elapsed, the computer system collectively syncing multiple card transactions to the server computer of the card provider organization.

13. The computer program product of claim 8, wherein the method further comprises:
the computer system receiving a specified time frame for removing data about users;
the computer system determining that for the specified time frame, the user has not initiated any card transaction for purchasing from any merchant included in the multiple merchants included in the trade organization; and
in response to the determining that for the specified time frame, the user has not initiated any card transaction for purchasing from any merchant included in the multiple merchants, the computer system removing data about the user from the server computer of the trade organization.

14. The computer program product of claim 8, wherein the method further comprises:
the computer system detecting the card being swiped in a merchant terminal by the user;
in response to the detecting the card being swiped, the computer system determining whether data about the user is present on the server computer of the trade organization; and
if the data about the user is not present on the server computer of the trade organization, the computer system receiving the data about the user from the server of the card provider organization, or if the data about the user is present on the server computer of the trade organization, the computer system validating the card for authentication and determining whether money available to the user for spending or dispensing is within a current limit associated with the card.

15. A computer-implemented method comprising:
receiving, by one or more processors of a computer system, data about spending by a user, the computer system being a server computer of a trade organization, the trade organization being established by a card provider organization to include multiple merchants, and the server computer of the trade organization being configured to authorize or decline card transactions;
based on the received data about spending by the user and by using a machine learning system, determining, by the one or more processors, a predictive pattern of spending by the user;
detecting, by the one or more processors, a card transaction initiated by the user using a card to make a purchase from a merchant included in the trade organization and obtaining card transaction information about the card transaction via an intranet;
determining, by the one or more processors, that the card transaction information matches the predictive pattern of spending; and
in response to the determining that the card transaction information matches the predictive pattern of spending, authorizing, by the one or more processors, the card transaction without sending the card transaction information via the internet and without sending the card transaction information to a server of the card provider organization or a computer network of the card provider organization.

16. The method of claim 15, wherein the method further comprises:
the computer system detecting a second card transaction initiated by a usage of the card to make a second purchase and obtaining second card transaction information about the second card transaction via the intranet;
the computer system determining that the second card transaction information does not match the predictive pattern of spending; and
in response to the determining that the second card transaction information does not match the predictive pattern of spending, the computer system declining the second card transaction by sending the second card transaction information to the server of the card provider organization for a verification and an authorization of the second card transaction.

17. The method of claim 15, wherein the method further comprises:
the computer system receiving a range of variation the predictive pattern of spending, wherein the determining that the card transaction information matches the predictive pattern of spending includes determining a variance that the card transaction information has from the predictive pattern of spending and determining that the variance is within the range of variation.

18. The method of claim 15, wherein the method further comprises:
the computer system detecting a first time card transaction initiated by the user using the card for purchasing from the merchant included in the trade organization, the first time card transaction being a first time the card is used for purchasing from any merchant included in the multiple merchants included in the trade organization; and
in response to the detecting the first time card transaction, the computer system preventing an authorization of a parallel card transaction associated with the trade organization during a time frame of the first time card transaction, until a sync occurs between the computer system and the server computer of the card provider organization.

19. The method of claim 15, wherein the method further comprises:
the computer system receiving an interval of time for syncing card transactions;
the computer system determining that the interval of time has elapsed; and
in response to the determining that the interval of time has elapsed, the computer system collectively syncing multiple card transactions to the server computer of the card provider organization.

20. The method of claim 15, wherein the method further comprises:
the computer system receiving a specified time frame for removing data about users;
the computer system determining that for the specified time frame, the user has not initiated any card transaction for purchasing from any merchant included in the multiple merchants included in the trade organization; and
in response to the determining that for the specified time frame, the user has not initiated any card transaction for purchasing from any merchant included in the multiple merchants, the computer system removing data about the user from the server computer of the trade organization.
